(19) United States
(12) Patent Application Publication
(10) Pub. No.: US 2015/0061514 A1
(43) Pub. Date: Mar. 5, 2015

(54) LIGHT EMITTING DIODE DRIVING DEVICE

(71) Applicant: Chicony Power Technology Co., Ltd., New Taipei City (TW)

(72) Inventors: Chien-Hung CHEN, New Taipei City (TW); Jhe-Yu LIN, New Taipei City (TW); Chih-Wei HSU, New Taipei City (TW); Chung-Shu LEE, New Taipei City (TW)

(73) Assignee: Chicony Power Technology Co., Ltd., New Taipei City (TW)

(21) Appl. No.: 14/269,710

(22) Filed: May 5, 2014

(30) Foreign Application Priority Data
Aug. 28, 2013 (TW) 102216133

(51) Int. Cl. H05B 33/08

(52) U.S. Cl. CPC H05B 33/0815; H05B 33/0824
USPC 315/186

(57) ABSTRACT

A LED driving device is electrically connected to a voltage power source and a plurality of LED strings. The LED driving device includes a constant-voltage outputting module, a rectifying unit, and a constant-current controlling unit. The constant-voltage outputting module is electrically connected to the voltage power source and includes a switching unit, a resonant unit, a converting unit, and a power-balancing unit. The resonant unit is electrically connected to the switching unit. The converting unit includes a primary winding, two first secondary windings, and a second secondary winding. The primary winding is electrically connected to the resonant unit. The power-balancing unit includes a balancing converter including two balancing windings electrically connected to the first secondary windings. The rectifying unit is electrically connected to the power-balancing unit and the LED strings, the constant-current controlling unit is electrically connected to the second secondary winding and the LED strings.

### BACKGROUND OF THE INVENTION

1. Field of the Invention

The present invention relates to a driving device, and in particular to a light emitting diode (LED) driving device.

2. Description of Related Art

Flat display device, such as a liquid crystal display apparatus, has advantages of high quality, small size and light weight, and become the mainstream of the display device. In order to achieve characteristic of low power consumption, light emitting diodes (LEDs) having advantage of small power consumption are applied to replace incandescent or fluorescent tube and provide light source for flat display device.

LED is a low-voltage single-conduct component driven by current, and its luminous flux is changed according to current flowing therethrough. Owing to the fact that it is mentioned above, a flat display device with uniform illumination can be achieve by providing a constant current to strings or matrix composed of LEDs. In the past, a constant-current component, such as current mirror, is applied to each LED string of LED driving circuit to stabilize current flowing therethrough, however the skeleton of the LED driving circuit is then becoming huge. Thus how to effectively stabilize flowing through all LED strings electrically connected to the LED driving device and minimize skeleton of the LED driving device becomes anxious problem for people skilled in the art.

### SUMMARY OF THE INVENTION

It is an object to provide a LED driving device, the LED driving device is configured to provide a constant voltage and a constant current to LED strings such that the LED strings can be let with uniform illumination.

Accordingly, the LED driving device according to one aspect of the present invention is electrically connected to a voltage power source and a plurality of LED strings. The LED driving device comprises a constant-voltage outputting module, a rectifying unit, and a constant-current controlling unit. The constant-voltage outputting module is electrically connected to the voltage power source and comprises a switching unit, a resonant unit, a converting unit, and a power-balancing unit. The resonant unit is electrically connected to the switching unit. The converting unit comprises a primary winding, two second secondary windings, and a second secondary winding. The primary winding is electrically connected to the resonant unit. The power-balancing unit comprises a balancing converter comprising two balancing windings. The balancing windings are electrically connected to the primary winding. The rectifying unit is electrically connected to the power-balancing unit and the LED strings. The constant-current controlling unit is electrically connected to the second secondary winding and the LED strings.

In an embodiment of the present invention, the constant-current controlling unit comprises a driving component and a power-converting circuit, the driving component is electrically connected to the LED strings, the power-converting circuit is electrically connected to the second secondary winding.

In an embodiment of the present invention, the power-balancing unit further comprises two balancing capacitors electrically connected to the first primary winding and the rectifying unit, each balancing capacitor, each first secondary winding, and each balancing winding are electrically connected in parallel.

In an embodiment of the present invention, the LED driving device further comprises a controller electrically connected to the second secondary winding and the switching unit, the controller is configured to control switching frequencies of the switching unit.

In an embodiment of the present invention, the LED driving device further comprises a plurality of protecting capacitors, each protecting capacitor is electrically connected to each LED string in series.

In an embodiment of the present invention, the rectifying unit comprises two first rectifiers and two second rectifier, the first rectifiers are electrically connected to the first secondary windings and the LED strings, respectively, the second rectifier is electrically connected to the second secondary winding.

In an embodiment of the present invention, the LED driving device further comprises a voltage-level sensing capacitor electrically connected to the second rectifier.

In an embodiment of the present invention, the balancing windings comprise the same turn number.

In an embodiment of the present invention, the resonant unit comprises a resonant capacitor, a resonant inductor, and a magnetizing inductor, the resonant capacitor, the resonant inductor, and the magnetizing inductor are electrically connected in series, the magnetizing inductor is electrically connected to the primary winding in parallel.

In an embodiment of the present invention, the switching unit comprises two switching components electrically connected to the controller, the controller is configured to modulated switching frequencies of the switching components.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit block diagram of a light emitting diode (LED) driving device according to the present invention.

FIG. 2 is a circuit diagram of the LED driving device according to the present invention.

### DETAILED DESCRIPTION OF THE INVENTION

A preferred embodiment of the present invention will be described with reference to the drawings.

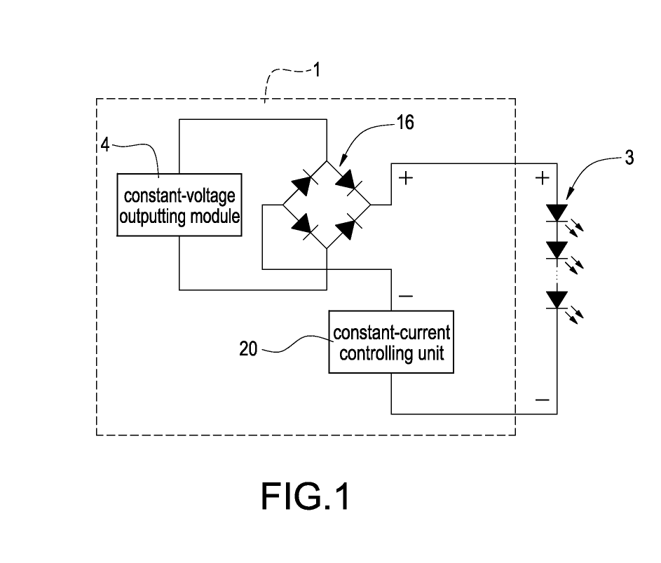

Reference is made to FIG. 1, which is a circuit block diagram of a light emitting diode (LED) driving device according to the present invention. The LED driving device 1 is electrically connected to a plurality of LED strings 3 for illuminating the LED strings 3. The LED driving device 1 includes a constant-voltage outputting module 4, a rectifying unit 16, and a constant-current controlling unit 20. The constant-voltage outputting module 4 is configured to output a constant voltage to conduct the LED strings. The constant-current controlling unit 20 is configured to output a constant current such that the LED strings 3 can be illuminated with uniform illumination.

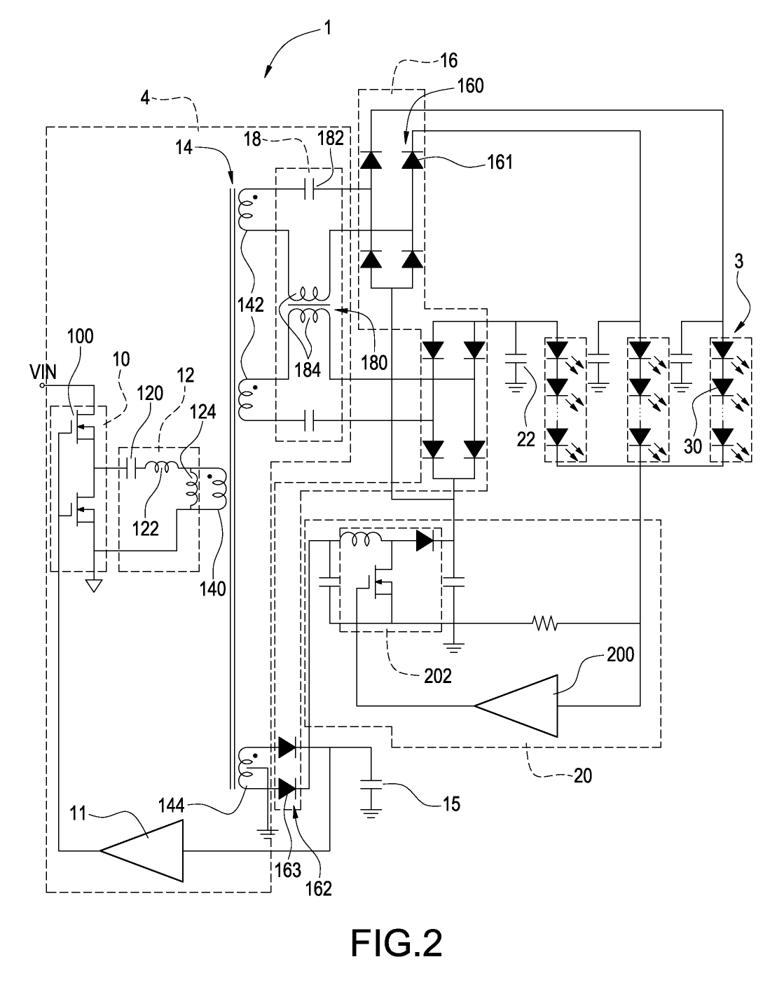

Reference is made to FIG. 2, which is a circuit diagram of the LED driving device according to the present invention. The LED driving device 1 is electrically connected to a voltage power source VIN and LED strings 3. The voltage power source VIN is direct current (DC) voltage power source. The LED strings 3 include a plurality of LED components 30 electrically connected in series. In this embodiment, an amount of the LED strings 3 is, for example, three. Each LED component 30 is, for example, LED die or LED package, wherein LED die is composed of a plurality of semiconductor layers, and LED package is LED die mentioned above covered with transmissive resin or phosphor. The LED driving device 1 is configured to drive the LED strings 3 such that the LED strings 3 can be illuminated with uniform illumination.

The constant-voltage outputting module 4 includes a switching unit 10, a resonant unit 12, a converting unit 14, and a power-balancing unit 18. The switching unit 10 is electrically connected to the voltage power source VIN. The resonant unit is electrically connected to the switching unit 10. The converting unit 14 is electrically connected to the resonant unit 12. The power-balancing unit 18 is electrically connected to the converting unit 14. The rectifying unit 16 is electrically connected to the power-balancing unit 18, the constant-current controlling unit 20, and the LED strings 3.

The switching unit 10 is configured to switch the voltage power source into pulsating DC signal, and in this embodiment, the switching unit 10 is a half-bridge switching circuit including two switching components 100. The switching components 100 are, for example, metal-oxide-semiconductor field-effect transistor (MOSFET). However, in the practical application, the switching unit 10 can be full-bridge switching circuit, and includes switching components such as insulated gate bipolar transistor (IGBT). The switching unit 10 is electrically connected to a controller 11. the controller 11 is configured to control switching frequencies of the switching components 100.

The resonant unit 12 is electrically connected to the switching components 100, and receives DC pulsating signal while the switching component 100 being turned-on and turned-off. Besides, the resonant unit 12 also modulates voltage level according to the pulsating signal outputted from the switching unit 100 such that a constant voltage can be outputted therefrom. The resonant unit 12 includes a resonant capacitor 120, a resonant inductor 122, and a magnetizing inductor 124. The resonant capacitor 120 is electrically connected to the resonant inductor 122 in series, and the magnetizing inductor 124 is electrically connected to a primary winding of the converting unit 12 in parallel. The magnetizing inductor 124 is also electrically connected to the resonant inductor 122. The resonant capacitor 120 is not only used for blocking DC component of the DC pulsating signal, but constructing a resonant tank with the resonant inductor 122 and the magnetizing inductor 124. In this embodiment, the magnetizing inductor 124 is an external inductor as shown in FIG. 2, however, the magnetizing-inductor 124 can also be magnetizing inductance of the converting unit 14.

The converting unit 14 includes a primary winding 140, two first secondary winding 142, and a second secondary winding 144. The primary winding 140 is electrically connected to the resonant unit 12 and converts electric energy into magnetic energy such that the task of stepping-up or stepping-down voltage magnitude is achieved. The first secondary windings 142 have the same turn number. The turn number of the second secondary winding 144 can be the same as the turn number of first secondary windings 144, or different form the turn number of the first secondary winding 142. In this embodiment, the second secondary winding 144 is a center-tapped converter.

The second secondary winding 144 is electrically connected to a voltage-level sensing capacitor 15. The voltage-level sensing capacitor 15 is used for sensing outputting voltage of the second secondary winding 144. By modulating ratio of second secondary winding 144 and the first secondary winding 142, the voltage level of voltage outputted form the first secondary windings 142 can be sensed by sensing the voltage level of the voltage-level sensing capacitor 15. Besides, the controller 11 is also electrically connected to the second secondary winding 144, the controller 11 modulates levels of voltages outputted form the first secondary windings 142 and the second secondary winding 144 by detecting level of voltage outputted form the second secondary winding 144 and controlling switch frequencies of the switching component 100.

The rectifying unit 16 includes two first rectifier 160 and a second rectifier 162. The first rectifier 160 is electrically connected to the first secondary winding 142 and the LED strings 3 such that alternative current (AC) power source can be converted into DC current power source with high-frequency ripple component. In this embodiment, the first rectifier 160 is a full-bridge rectifying circuit composed of four diodes 161, and the second rectifier 162 is a fill-bridge composed of two diodes 163.

The power-balancing unit 18 includes a balancing converter 180 and two balancing capacitor 182. The balancing converter 180 includes two balancing windings 184 having the same turn number. The balancing windings 182 are electrically connected to the first secondary windings 142 and the first rectifier 160, respectively for balancing currents flow through the balancing windings 182 such that the currents flow through the rectifying unit 16 are uniform. The balancing capacitor 182 is electrically connected to the first secondary windings 142 and the first rectifier 160. The balancing capacitors 182 have function of stabilizing voltage. Each balancing capacitor 182, each first secondary winding 142, and each balancing winding 182 are electrically connected in series.

The constant-current controlling unit 20 includes a driving component 200 and a power-converting circuit 202. The driving component 200 is used for detecting current flow through the LED strings 3 and feedbacks the value of current mention above into the power-converting circuit 202. When value of current flows through the LED strings 3 is larger or smaller than a predetermined value, the power-converting circuit 202 reduces or increases level of voltage outputted form the constant-voltage outputting module 4, such that the current flows through the LED strings 3 can be maintained at the predetermined value. In this embodiment, the power-converting circuit 202 is, for example, a boosting circuit, however the power-converting circuit 202 can also be buck converting circuit.

Besides, the LED driving device 1 further comprises a plurality of protecting capacitor 22, each protecting capacitor 22 is electrically connected to each LED string 3 in parallel. Each LED string 3 has a particularly operating voltage, and the particularly operating voltage is equal to the sum of forward voltages of LEDs 30 of each LED string 3. Owing to the operating voltage of each LED string 3 is different the others, the voltage outputted form the first secondary winding 142 of the converting unit 14 must be the same as the largest operating voltage of the operating voltages of the LED strings 3, therefore the LED strings 3 can be driven successfully. Each protecting capacitor 22 is used for storing difference between the largest operating voltage and the operating voltage of the LED strings 3 smaller than the largest operating voltage to prevent the LEDs 30 from damaging causing by over-voltage.

It is noted that when the amount of the LED strings 3 is added, the amount of the first secondary winding 142, the balancing winding 182m and the first rectifier 160 must be correspondingly added. In additions, two LED strings 3 electrically connected in parallel can be added when a first secondary winding 142 is added. However, only one LED string 3 can be added while a first secondary winding 142 is added. Besides, while a first secondary winding 142 is added, a balancing winding 182 and a first rectifier 160 must be correspondingly added.

In the practical application, the switching unit 10 switches DC signal outputted form the voltage power source VIN and received form the LED driving device 1 into pulsating DC signal. The resonant unit 12 modulates voltage outputted from the switching unit 12 according to the switching frequency of the voltage, and then sends the modulated voltage to the converting unit 14. The converting unit 14 provides function of power conversion, the first secondary windings 142 thereof outputs a voltage for illuminating the LED strings 3, and the second secondary winding 144 thereof outputs a voltage for calibration.

The balancing winding 182 of the power balancing unit 18 is configured to uniform currents conducted to the first rectifier 160 of the converting unit 16, the balancing capacitor 182 is used for stabilizing voltage, therefore the currents flow through the LED strings 3 can be maintained in a predetermined value, and the LED strings 3 achieve uniform illumination. The driving component 200 of the constant-current controlling unit 20 is used for detecting whether currents flowing through the LED strings 3 achieve the predetermined value or not. For example, the constant-voltage module 4 must output 600 mA if current flows through each LED string 3 is 200 mA. The constant-voltage outputting module 4 maintains voltage outputted therefrom in a constant value while the voltage outputted form the constant-voltage outputting module 4 makes current flows through the LED strings 3 achieve the predetermined value. However, if the current outputted form the constant-voltage outputting module 4 and detected by the constant-current controlling unit 20 cannot achieve the predetermined value, the driving component 300 sent a signal to the power-converting circuit 202 and makes the controller 11 modulate switching frequencies of the switching component 100 to u=increase value of voltage conducted to the LED strings 3.

To sum up, the LED driving device 1 according to the present invention uses the constant-voltage outputting module 4 and the constant-current controlling unit 20 to maintain values of voltage and current conduct to the LED strings 3, such that the LED strings 3 can be illuminated with uniform illumination. Besides, the constant-voltage outputting module 4 and the constant-current controlling unit 20 of the LED driving device 1 according to the present invention can simultaneously electrically connected to multiple LED strings 3, therefore volume of the LED driving device 1 can be reduced during to circuit skeleton of the LED driving device 1 is scaled down.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A light emitting diode (LED) driving device electrically connected to the voltage power source and a plurality of LED strings, the LED driving device comprising:
a constant-voltage outputting module electrically connected to the voltage power source, the constant-voltage outputting module comprising:
a switching unit;
a resonant unit electrically connected to the switching unit;
a converting unit comprising a primary winding, two first secondary windings, and a second secondary winding, the primary winding electrically connected to the resonant unit; and
a power-balancing unit comprising a balancing converter, the balancing converter comprising two balancing windings electrically connected to the first secondary windings;
a rectifying unit electrically connected to the power-balancing unit and the LED strings; and
a constant-current controlling unit electrically connected to the second secondary winding and the LED strings.

2. The LED driving device in claim 1, wherein the constant-current controlling unit comprises a driving component and a power-converting circuit, the constant-current controlling unit is electrically connected to the LED strings, and the power-converting circuit is electrically connected to the driving component and the second secondary winding.

3. The LED driving device in claim 2, wherein the power-balancing unit further comprises two balancing capacitors electrically connected to the first secondary windings and the rectifying unit, each balancing capacitor, each first secondary winding, and each balancing winding are electrically connected in in series.

4. The LED driving device in claim 3, further comprising a controller electrically connected to the second secondary winding and the switching unit, the controller is configured to control switching frequencies of the switching unit.

5. The LED driving device in claim 4, further comprising a plurality of protecting capacitors, each protecting capacitor is electrically connected to each LED string in parallel.

6. The LED driving device in claim 5, wherein the rectifying unit comprises two first rectifiers and two second rectifier, the first rectifiers are electrically connected to the first secondary windings and the LED strings, respectively, the second rectifier is electrically connected to the second secondary winding.

7. The LED driving device in claim 6, further comprising a voltage-level sensing capacitor electrically connected to the second rectifier.

8. The LED driving device in claim 7, wherein the balancing windings comprise the same turn number.

9. The LED driving device in claim 8, wherein the resonant unit comprising a resonant capacitor, a resonant inductor, and a magnetizing inductor, the resonant capacitor, the resonant inductor, and the magnetizing inductor are electrically connected in series, the magnetizing inductor is electrically connected to the primary winding in parallel.

10. The LED driving device in claim 9, wherein the switching unit comprises two switching components electrically connected to the controller, the controller is configured to modulate switching frequencies of the switching components.
